(19) United States
(12) Patent Application Publication
(10) Pub. No.: US 2015/0017039 A1
(43) Pub. Date: Jan. 15, 2015

(54) HIGH-PRESSURE FUEL SUPPLY PUMP HAVING AN ELECTROMAGNETICALLY-DRIVEN INLET VALVE

(71) Applicant: Hitachi Automotive Systems, Ltd., Hitachinaka-shi, Ibaraki (JP)

(72) Inventors: Satoshi Usui, Hitachinaka (JP); Tatsuo Kawano, Hitachinaka (JP); Hiroyuki Yamada, Hitachinaka (JP); Katsumi Miyazaki, Hitachinaka (JP); Kenta Iwakura, Hitachinaka (JP); Minoru Hashida, Hitachinaka (JP)

(73) Assignee: Hitachi Automotive Systems, Ltd., Hitachinaka-shi, Ibaraki (JP)

(21) Appl. No.: 14/374,840

(22) PCT Filed: Jan. 15, 2013
(86) PCT No.: PCT/JP2013/050504

§ 371 Date: Jul. 25, 2014

(30) Foreign Application Priority Data
Feb. 27, 2012 (JP) 2012-039517

(51) Int. Cl. F02M 51/04; F04B 7/00

(52) U.S. Cl. CPC F02M 51/04; F04B 7/0076
USPC 417/505

(57) ABSTRACT

A high-pressure fuel supply pump having a normally-closed type electromagnetically-driven inlet valve mechanism supporting a large capacity and causing least sound is provided. A valve member having a seat surface that comes into abutment with an inlet valve seat; and a plunger rod positioned on the seat surface side of the valve member and configured to operate the valve member by a magnetic attraction force are provided, and a protector configured to face a surface of the valve member on the surface opposite to the seat surface with a gap therebetween when the plunger rod makes a full stroke in the valve-open direction of the valve member and an anchor for driving the plunger rod comes into contact with a stopper is provided.

### TECHNICAL FIELD

The present invention relates to a high-pressure fuel supply pump used for an in-cylinder injecting type internal combustion engine, which is a high-pressure fuel supply pump having an electromagnetically-driven inlet valve mechanism and, specifically to a high-pressure fuel supply pump including an electromagnetically-driven inlet valve mechanism in which the electromagnetically-driven inlet valve mechanism includes a valve member and a plunger rod being an all-in-one type, and is a so-called normally-closed type in which a spring for biasing the plunger rod biases the valve member in the valve-close direction.

### BACKGROUND ART

In a high-pressure fuel supply pump having an electromagnetically-driven inlet valve mechanism disclosed in JP-A-2006-250086, the electromagnetically-driven inlet valve mechanism integrally includes the valve member at a distal end of a movable plunger which is operated by an electromagnetic force, includes a restricting member configured to restrict the displacement of the plunger at a specific position, includes a spring member configured to urge the movable plunger to a side opposite to the restricting member, is configured in such a manner that a fluid differential pressure between above and below of a valve seat acts in the same direction as the movement of the movable plunger caused by the electromagnetic force to help the movement of the movable plunger, and is configured in such a manner that the electromagnetic force acts on the plunger after the movable plunger has specifically displaced toward the restricting member by the fluid differential pressure.

The electromagnetically-driven inlet valve mechanism having such a configuration is configured in such a manner that when a piston plunger of the pump is changed from a suction stroke in which a piston plunger of the pump moves from a top dead center position toward a bottom dead center position to a discharge stroke in which the piston plunger of the pump reversely moves from the bottom dead center position toward the top dead center position, fuel taken into a pressurizing chamber during the suction stroke is discharged from an opening of an inlet opening of the pressurizing chamber to the valve member side, flows reversely through the periphery of the valve member and a fuel channel between the valve seat and the valve member into a fuel outlet mouth of the electromagnetically-driven mechanism, and spills into a low pressure combustion chamber of the electromagnetically-driven mechanism.

In an electromagnetically-driven inlet valve mechanism of high-pressure fuel supply pump described in JP-A-2006-291838, while an electromagnetically-driven mechanism is not energized, a valve member of an inlet valve is biased by a spring force in the valve-open direction via a plunger of the electromagnetically-driven mechanism and hence moves away from the valve seat, and is maintained at a valve-open position. An isolating member configured to isolate the inlet valve from the fluid channel is provided on the back side of the inlet valve arranged in the fluid channel between an inlet mouth and the pressurizing chamber so as to avoid a fluid force (dynamic pressure) of a fuel flow overflowing while passing through the fluid channel. Accordingly, there is a description saying that the fluid force acting on the inlet valve by a fuel flowing reversely during the returning stroke (overflowing stroke) can be reduced, and hence a load on an actuator can be reduced, whereby a high-rotation and a high-flow rate can be supported. More specifically, there is a description of the high pressure fuel pump having a configuration including the pressurizing chamber configured to pressurize the fluid, and the inlet valve provided on the pressurizing chamber side of the inlet mouth so as to open and close the inlet mouth formed at an entrance of the pressurizing chamber and configured to be biased in the direction of closing the inlet mouth by the spring, in which the isolating member provided in the fluid channel between the pressurizing chamber and the inlet mouth and configured to isolate a back surface portion of the inlet valve from the fluid channel.

### CITED REFERENCE

### Patent Literature

PTL 1: JP-A-2006-250086

PTL 2: JP-A-2006-291838

### SUMMARY OF INVENTION

### Technical Problem

However, according to the electromagnetically-driven inlet valve mechanism as the former example, the fluid force of the fuel flow flowing reversely from the pressurizing chamber acts on the surface of the valve member on the pressurizing chamber side, and biases the valve member in the opened state in the valve-close direction. When the fluid force of the fuel flow flowing reversely increases as a result of increase in capacity, a large electromagnetic force is required for maintaining the valve-open state without being affected by the fluid force correspondingly, so that there is a problem of an increase in size of the electromagnetically-driven mechanism. When changing the point of view, it is the same as a problem that the valve member comes into contact with an inlet valve seat to assume the valve-closed state if the fluid force in the valve-close direction which acts on the valve member is increased to a level larger than a magnetic attraction force at an unexpected timing, and hence a flow rate cannot be controlled accurately, and a problem that a holding current following a starting current of the electromagnetically-driven mechanism cannot be reduced.

The configuration described in the latter Patent Literature has a problem that the inlet valve member, when reaching a fully opened state, hits against a baffle plate and causes a noise. With the configuration in this Patent Literature, an impact sound between the plunger and the restricting member, an impact sound between an anchor provided on a plunger rod and a fixing core, and an impact sound between a distal end of the plunger rod and the inlet valve member are generated, and hence there exists a problem that there are many sound generating portions.

It is an object of the invention to solve at least one of the above-described problems by applying a technology disclosed in the latter Patent Literature to a electromagnetically-driven inlet valve mechanism including the valve member and the plunger rod of an all-in-one type and being a so-called normally-closed type having the valve member biased in the valve-close direction by a spring configured to bias the plunger rod, and obtain a high-pressure fuel supply pump having a normally-closed type electromagnetically-driven inlet valve mechanism supporting a large capacity and causing least sound.

### Solution to Problem

In order to achieve the above-described object, the invention includes a valve member having a seat surface that comes into abutment with an inlet valve seat, and a plunger rod positioned on the seat surface side of the valve member and configured to operate the valve member by a magnetic attraction force, and a protector configured to restrict a fluid pressure from acting on the surface of the valve member on the side opposite to the seat surface by forming a minimum gap with respect to a surface of the valve member on a surface opposite to the seat surface when the plunger rod makes a full stroke in the valve-open direction of the valve member and an anchor for driving the plunger rod comes into contact with a stopper.

### Advantageous Effects of Invention

Accordingly, the fluid force in the valve-close direction generated in the valve member by a fluid flowing through the valve member may be reduced, in other words, the fluid force may be reduced to a level smaller than the magnetic attraction force generated in the direction of maintaining the valve-open state, in which the valve member is apart from the inlet valve seat. Also, since the protector and the inlet valve member do not come into contact with each other, generation of a sound is not increased. Therefore, even when the capacity is increased, an accurate flow rate control is enabled and a high-pressure fuel supply pump generating least sound is provided.

### BRIEF DESCRIPTION OF DRAWINGS

FIG. 1 is an example of a fuel supply system composed of a high-pressure fuel supply pump provided with an electromagnetically driven inlet valve according to a first example in which the invention is implemented.

FIG. 2 is a vertical cross-sectional view of the high-pressure fuel supply pump provided with the electromagnetically-driven inlet valve according to the first example in which the invention is implemented.

FIG. 3 is an enlarged view of the high-pressure fuel supply pump provided with the electromagnetically-driven inlet valve according to the first example in which the invention is implemented, and illustrates a state in which an electromagnetic coil is not excited,

FIG. 4 is an enlarged view of the high-pressure fuel supply pump provided with the electromagnetically-driven inlet valve according to the first example in which the invention is implemented, and illustrates a state in which the electromagnetic coil is excited.

FIG. 5 is perspective view of the high-pressure fuel supply pump provided with the electromagnetically-driven inlet valve according to the first example in which the invention is implemented, and illustrates a state in which the electromagnetic coil is not excited.

FIG. 6 is perspective view of the high-pressure fuel supply pump provided with the electromagnetically-driven inlet valve according to the first example in which the invention is implemented, and illustrates a state in which the electromagnetic coil is excited.

FIG. 7 illustrate a state before the high-pressure fuel supply pump provided with the electromagnetically-driven inlet valve of the first example in which the invention is implemented is assembled to a pump housing 1.

FIG. 8 is a time chart diagram for explaining an action of the high-pressure fuel supply pump provided with the electromagnetically-driven inlet valve according to the first example in which the invention is implemented.

### DESCRIPTION OF EMBODIMENTS

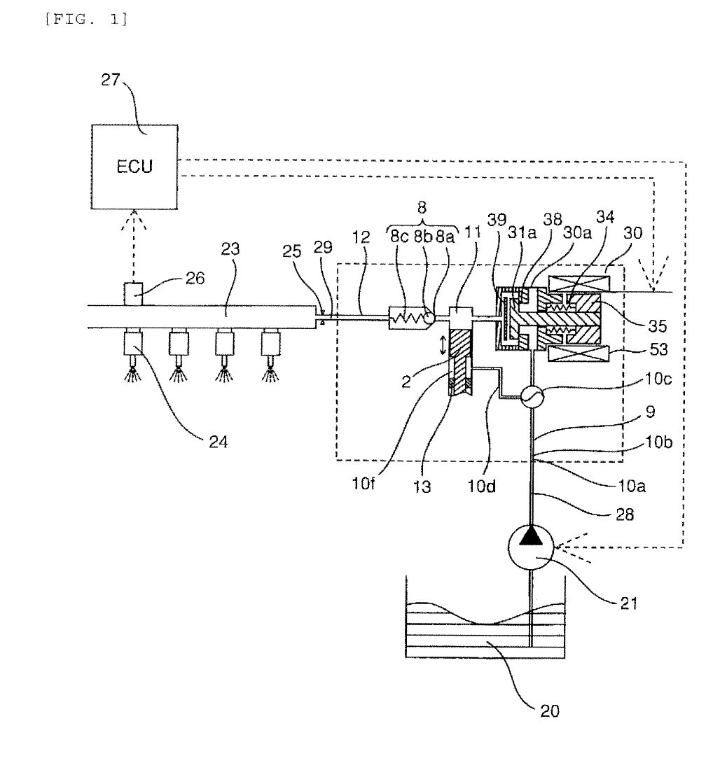

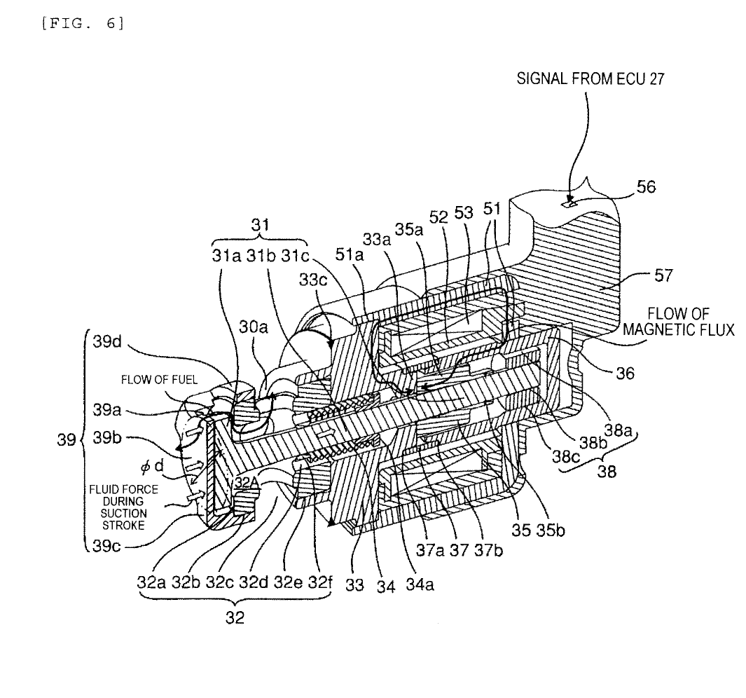

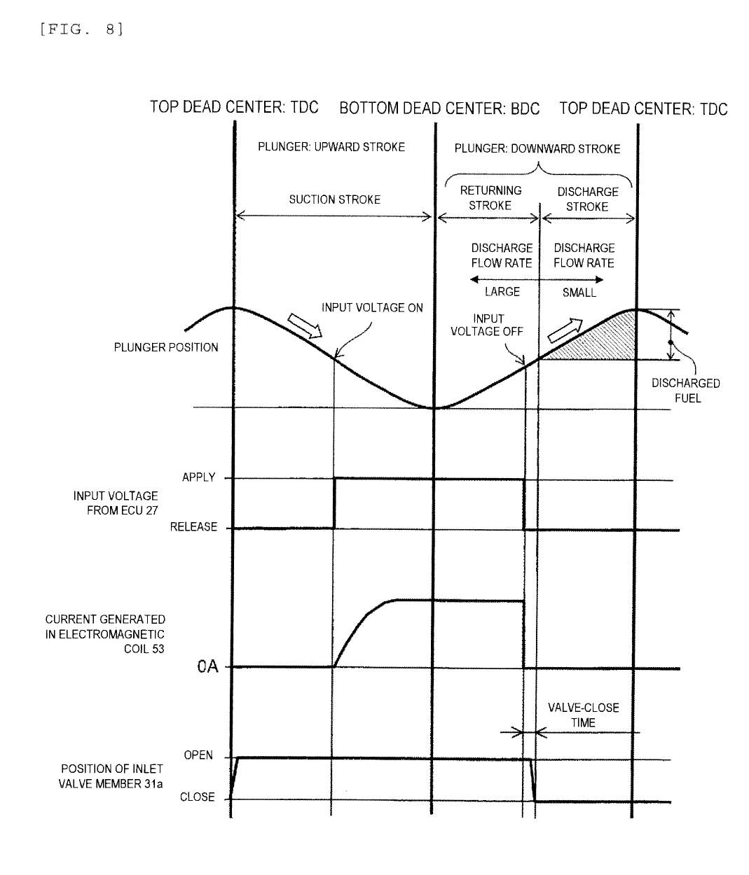

Referring now to FIG. 1 to FIG. 8, an example of a high-pressure fuel supply pump provided with an electromagnetically-driven inlet valve of the invention will be described.

An electromagnetically-driven inlet valve mechanism of the high-pressure fuel supply pump of this example is configured as follows.

It is a so-called normally-closed type in which a valve member 31a and a plunger rod 31b are all-in-one type, and a spring 34 configured to bias the plunger rod 31b biases a valve member 31a in a valve-close direction.

The electromagnetically-driven inlet valve mechanism includes a plunger rod 31b operated by an electromagnetic force generated by an electromagnetic coil 53. An anchor 35 fixed to an anchor fixing portion 31c of the plunger rod 31b is attracted by an electromagnetic force to a fixing core 33, and hits against an end surface of the fixing core 33. Therefore, the fixing core 33 functions as a restricting member that restricts a displacement of the plunger rod 31b at a specific position.

The spring 34 is held between a spring stopper 34a fixed to the plunger rod 31b and an inlet valve seat housing 32, and is configured to bias the plunger rod 31b away from the restricting member (fixing core 33). A fluid differential pressure between upstream and downstream of the valve member 31a acts to bias the valve member 31a in the valve-open direction, and resists a biasing force of the spring 34. The electromagnetic force resists an acting force of the spring 34 that biases the plunger rod 31b away from the restricting member (fixing core 33), goes along with an acting force by the fluid differential pressure that biases the valve member 31a in the valve-open direction to bias the valve member 31a in the valve-open position, or maintains the valve-open state of the valve member 31a.

Specifically, after the valve member 31a and the plunger rod 31b have made a specific displacement (in the example, these members are configured to be displaced to a fully-opened position) toward the restricting member (fixing core 33), that is, in the valve-open direction of the valve member 31a by a fluid differential pressure while compressing the spring 34, the electromagnetic coil 53 is excited to cause an electromagnetic force to act on the anchor 35 of the plunger rod 31b, so as to maintain the anchor 35 in a state of being in contact with the fixing core 33.

The electromagnetically-driven inlet valve mechanism having such a configuration is configured in such a manner that when a piston plunger 2 of the high-pressure fuel supply pump is changed from a suction stroke in which a piston plunger of the pump moves from a top dead center position toward a bottom dead center position to a discharge stroke in which the same reversely moves from the bottom dead center position toward the top dead center position, fuel taken into a pressurizing chamber 11 during the suction stroke is discharged from an inlet opening (also functions as a spill opening) 11A of an inlet mouth of the pressurizing chamber 11 to the valve member 31a side.

In other words, the fuel flows reversely in a fuel outlet mount channel of an electromagnetically-driven inlet valve mechanism 30 formed in the periphery of the valve member 31a and between an inlet valve seat portion 32a and the valve member 31a and spills into an inlet port 30a of the electromagnetically-driven inlet valve mechanism 30.

The valve member 31a having a seat surface 31A coming into abutment with an inlet valve seat portion 32a and a valve-plunger unit 31 positioned on the seat surface 31A side of the valve member 31a and configured to operate the valve member 31a by an electromagnetic force are provided, a protector 39 as a wall surface member having a flat plate portion 39b configured to oppose a surface of the valve member 31a opposite to the seat surface 31A with a gap GA therebetween when the anchor 35 for driving the plunger fixed to the plunger rod 31b comes into contact with a magnetic sucking portion 33a of the fixing core 33 as the stopper or the restricting member and the plunger rod 31b makes a full stroke in the opening direction of the valve member 31a is provided, and the protector 39 is provided between the surface 31B on the side opposite to the seat surface 31A of the valve member 31a and an inlet opening (which is also a spill opening) 11A of the pressurizing chamber 11.

The gap GA between the valve member 31a and the protector 39 is always larger than the gap GB between the anchor 35 as a movable member and the magnetic sucking portion 33a of the fixing core 33 as the stopper or the restricting member.

At a maximum compressed position of the spring 34 configured to bias the plunger rod 31b in the valve-close direction of the valve member 31a, the valve member 31a reaches the fully-opened position. At this time, the distance GA between the valve member 31a and the protector 39 becomes a minimum distance larger than zero. In other words, in a state in which a wall surface member having a flat disc-shaped portion that faces an end surface portion of the valve member 31a on the opposite side to the valve seat 32a side is provided and the valve member has made a full stroke in the valve-open direction, a thin layer of fuel is interposed between an end surface portion of the valve member 31a and the protector 39 as the wall surface portion having a flat disc-shaped portion so as to keep the both out of contact. Accordingly, in the electromagnetically-driven inlet valve mechanism having the plunger rod 31b and the valve member 31a of all-in-one type, an impact at the time of collision between the anchor 35 as the movable member and the magnetic sucking portion 33a of the fixing core 33 as the stopper or as the restricting member is alleviated. Accordingly, the impact sound may be reduced.

The protector 39 is fixed to a distal end outer periphery press-fit portion 32b of the inlet valve seat housing 32 as a member provided with the inlet valve seat portion 32a formed thereon by press-fitting.

An outer peripheral surface 39d of the protector 39 and an outer peripheral surface of the inlet valve seat housing 32 as a member provided with the inlet valve seat portion 32a formed thereon are fixed separately to the pump housing 1 by press-fitting.

Referring now to FIG. 1 to FIG. 8, an example of the invention will be described further in detail. In FIG. 1, a portion surrounded by a broken line indicates the pump housing 1 of a high-pressure pump, and this means that mechanisms and components indicated in the broken line are assembled integrally with the pump housing 1 of the high-pressure pump.

Fuel in a fuel tank 20 is pumped up by a feed pump 21 on the basis of a signal from an engine control unit 27 (hereinafter, referred to as an ECU), and is pressurized by an adequate feed pressure, thereby being fed through an inlet pipe 28 to an inlet mouth 10a of the high-pressure fuel supply pump.

The fuel passed through the inlet mouth 10a passes through a filter 102 fixed to the interior of an inlet joint 101, and reaches the inlet port 30a of the electromagnetically-driven inlet valve mechanism 30, which constitutes a capacity variable mechanism, via an inlet flow channel 10b, a metallic diaphragm damper 9, and an inlet flow channel 10c.

The inlet filter 102 in the inlet joint 101 has a role to prevent foreign substances existing in a range from the fuel tank 20 to the inlet mouth 10a from being absorbed in the high-pressure fuel supply pump by a fuel flow.

A depressed portion 1A is formed as the pressurizing chamber 11 at a center of the pump housing 1, and a bore 11B for mounting a discharge valve mechanism 8 is formed so as to open to the pressurizing chamber 11.

The discharge valve mechanism 8 is provided at an exit of the pressurizing chamber 11. The discharge valve mechanism 8 includes a seat member (seat member) 8a, a discharge valve 8b, a discharge valve spring 8c, and a holding member 8d as a discharge valve stopper, and the discharge valve mechanism 8 is assembled by welding a welding portion 8e on the outside of the pump housing 1. Subsequently, the assembled discharge valve mechanism 8 is press-fitted and fixed to the pump housing 1 from the left side in the drawing. The press-fit portion has a function to isolate the pressurizing chamber 11 from the discharge mouth 12.

In a state in which the pressure difference of a fuel does not exist between the pressurizing chamber 11 and the discharge mouth 12, the discharge valve 8b is pressure-bonded to the sheet member 8a by a biasing force of the discharge valve spring 8c, and is in the valve-closed state. The discharge valve 8b opens against the discharge valve spring 8c only when a fuel pressure in the pressurizing chamber 11 exceeds a fuel pressure of the discharge mouth 12 by a predetermined value, and fuel in the pressurizing chamber 11 is discharged to a common rail 23 via the discharge mouth 12.

The discharge valve 8b comes into contact with the holding member 8d when opened, and the action is restricted thereby. Therefore, the stroke of the discharge valve 8b is determined adequately by the holding member 8d. If the stroke is too large, fuel discharged to the fuel discharge mouth 12 flows reversely to the pressurizing chamber 11 by the delay of closing of the discharge valve 8b. Therefore, the efficiency as the high-pressure pump is lowered. When the discharge valve 8b repeats the valve opening and valve closing motion, the discharge valve 8b is guided by holding member 8d so as to move only in the direction of the stroke. In this configuration, the discharge valve mechanism 8 serves as a check valve that limits the direction of circulation of the fuel.

A cylinder 6 is held on an outer periphery thereof by a cylindrical fitting portion 7a of a cylinder holder 7. The cylinder 6 is fixed to the pump housing 1 by screwing a screw 7g formed on an outer periphery of the cylinder holder 7 into a screw 1b formed on the pump housing 1.

A plunger seal 13 is held at a lower end of the cylinder holder 7 by a seal holder 13A and the cylinder holder 7 press-fitted and fixed to the inner peripheral cylindrical surface 7c of the cylinder holder 7. At this time, the plunger seal 13 is held with an axis thereof so as to extend coaxially with an axis of the cylindrical fitting portion 7a by the inner peripheral cylindrical surface 7c of the cylinder holder 7. The piston plunger 2 and the plunger seal 13 are installed in slidable contact with each other at a lower end of the cylinder 6 in the drawing.

Accordingly, the fuel in the seal chamber 10f is prevented from flowing into a tappet 3 side, that is, into the interior of the engine. At the same time, lubricant (including engine oil) for lubricating the sliding portion in the interior of an engine room is prevented from flowing into the interior of the pump housing 1.

The cylinder holder 7 is provided with an outer peripheral cylindrical surface 7b, and a groove 7d for fitting an O-ring 61 is provided thereon. The O-ring 61 isolates a cam side from the outside by an inner wall of a fitting hole 70 on the engine side and the groove 7d of the cylinder holder 7 to prevent the engine oil from leaking outward.

The cylinder 6 includes a pressure-bonded portion 6a that intersects the direction of reciprocal motion of the piston plunger 2, and the pressure-bonded portion 6a is pressure-bonded to a pressure-bonded surface 1a of the pump housing 1. The pressure bonding is performed by a thrust force generated by tightening the screw. The pressurizing chamber 11 is shaped by the pressure bonding described above, and needs to control a screw tightening torque so as to prevent the fuel from leaking from the pressurizing chamber 11 outward through the pressure-bonded portion even when the fuel in the pressurizing chamber 11 is pressurized to a high pressure.

Also, in order to maintain a sliding length of the piston plunger 2 and the cylinder 6 adequately, the cylinder 6 is configured to be inserted deeply into the pressurizing chamber 11. On the pressurizing chamber 11 side from the pressure-bonded portion 6a of the cylinder 6, a clearance 1B is provided between the outer periphery of the cylinder 6 and an inner periphery of the pump housing 1. Since the outer periphery of the cylinder 6 is held by the cylindrical fitting portion 7a of the cylinder holder 7, the outer periphery of the cylinder 6 and the inner periphery of the pump housing 1 can be prevented from coming into contact with each other by the provision of the clearance 1B.

In this manner the cylinder 6 is held so that the piston plunger 2 that performs a back-and-force motion in the pressurizing chamber 11 is held slidably in the direction of the back-and-force motion thereof.

At a lower end of the piston plunger 2, a tappet 3 configured to convert a rotary motion of a cam 5 mounted on a camshaft of the engine into a vertical motion, and transmit the same to the piston plunger 2 is provided. The piston plunger 2 is pressure-bonded to the tappet 3 by a spring 4 via a retainer 15. The retainer 15 is fixed to the piston plunger 2 by being press-fit. Accordingly, in association with the rotary motion of the cam 5, the piston plunger 2 can be moved back and force (reciprocally).

Here, the inlet flow channel 10c is connected to the seal chamber 10f via a passage, which is not illustrated, and the seal chamber 10f is always connected to a pressure of the inlet fuel. When the fuel in the pressurizing chamber 11 is pressurized to a high pressure, a minute amount of high-pressure fuel flows into the seal chamber 10f through a sliding clearance between the cylinder 6 and the piston plunger 2. However, the high-pressure fuel which is flowed in is released by an inlet pressure, so that breakage of the plunger seal 13 due to a high pressure is prevented.

The piston plunger 2 includes a large diameter portion 2a that slides with respect to the cylinder 6 and a small diameter portion 2b that slides with respect to the plunger seal 13. The diameter of the large diameter portion 2a is larger than the diameter of the small diameter portion 2b, and both are set to be coaxial with each other. The sliding portion with respect to the cylinder 6 is the large diameter portion 2a, and the sliding portion with respect to the plunger seal 13 is the small diameter portion 2b. Accordingly, a joint portion between the large diameter portion 2a and the small diameter portion 2b exist in the seal chamber 10f, and hence the capacity of the seal chamber 10f varies in association with the sliding motion of the piston plunger 2 and, accordingly, the fuel moves between the seal chamber 10f and the inlet flow channel 10c through a fuel channel, which is not illustrated.

The metallic diaphragm damper 9 includes two metallic diaphragms, which are fixed to each other by welding an outer periphery thereof on the welding portion over the entire circumference in a state in which gas is encapsulated in a space between the both diaphragms. The mechanism is such that when a low-pressure pressure pulse is loaded on both surfaces of the metallic diaphragm damper 9, the metallic diaphragm damper 9 changes its capacity, whereby a low-pressure pressure pulse is reduced.

Fixation of the high-pressure fuel supply pump to the engine is achieved by a flange 41, a setscrew 42, and a bush 43. The flange 41 is coupled at a welding portion 41a to the pump housing 1 by welding the entire circumference. In this example, the laser welding is used.

The pump housing 1 includes the depressed portion 1A as the pressurizing chamber 11 at a center thereof, and a bore 30A for mounting the electromagnetically-driven inlet valve mechanism 30 is formed so as to open in the pressurizing chamber 11.

The inlet valve seat housing 32 includes an inlet valve seat portion 32a, a press-fit portion 32b, an inlet channel portion 32c, a fuel communication channel 32d, a press-fit portion 32e, and a sliding portion 32f. The press-fit portion 32e is fixed by being press-fit into the fixing core 33. The inlet valve seat portion 32a is press-fit into the protector 39 at the press-fit portion 32b.

The protector 39 includes an opening portion 39a, a protector 39b, a fixing arm portion 39c, and a press-fit portion 39d. The press-fit portion 39d is fixed by being press-fit to the pump housing 1, and isolates the pressurizing chamber 11 from the inlet port 30a completely by the press-fit portion 32b and the press-fit portion 39d.

The fixing core 33 is fixed to the pump housing 1 by welding a welding portion 33c, and isolates the inlet port 30a from the outside of the high-pressure fuel supply pump. An inner yoke 36 is fixed to the fixing core 33 via a seal ring 37. The fixing core 33 and the seal ring 37 are fixed by welding the welding portion 37b, and the inner yoke 36 and the seal ring 37 are fixed by welding a welding portion 37a. Accordingly, the inside and the outside of the fixing core 33 and the inner yoke 36 are completely isolated.

A guide 38 includes an opening portion 38a, a sliding portion 38b, and a press-fit portion 38c, and is fixed to an interior of the inner yoke 36 by press-fitting the press-fit portion 38c.

A valve-plunger unit 31 is composed of three parts, namely, the valve member 31a, the plunger rod 31b, the anchor fixing portion 31c, and constitutes an inlet valve member. The anchor 35 is fixed to the anchor fixing portion 31c by welding a welding portion 35b.

The spring stopper 34a is fixed to the plunger rod 31b of the valve-plunger unit 31 by press-fitting, and the spring 34 is held between the spring stopper 34a and an end surface of the inlet valve seat housing 32 as illustrated.

With the configuration described thus far, the valve-plunger unit 31, the anchor 35, and the spring stopper 34a have an all-in-one structure.

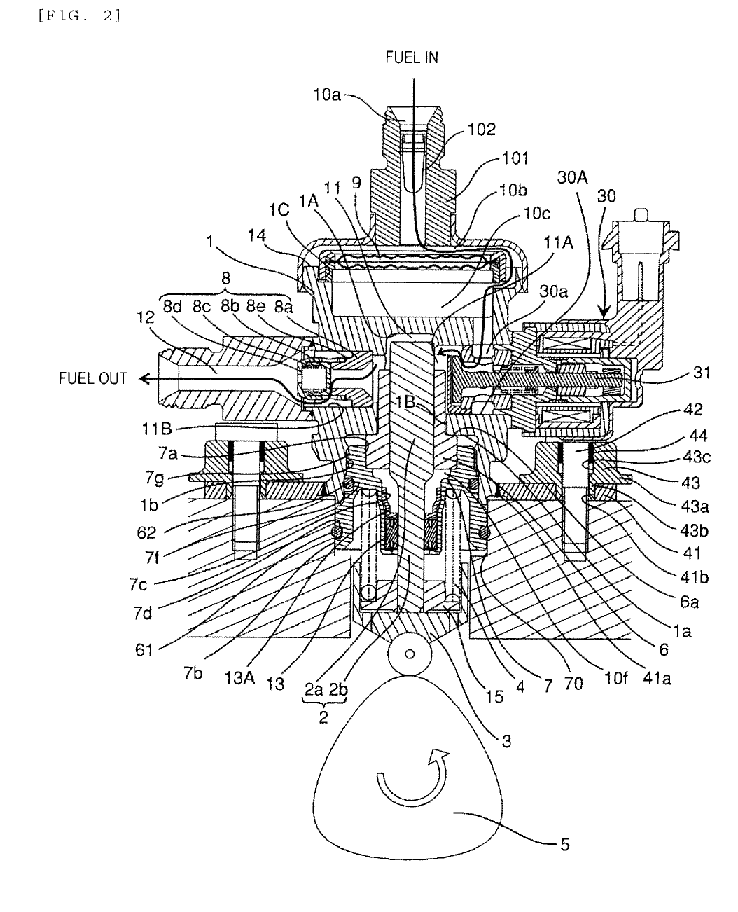

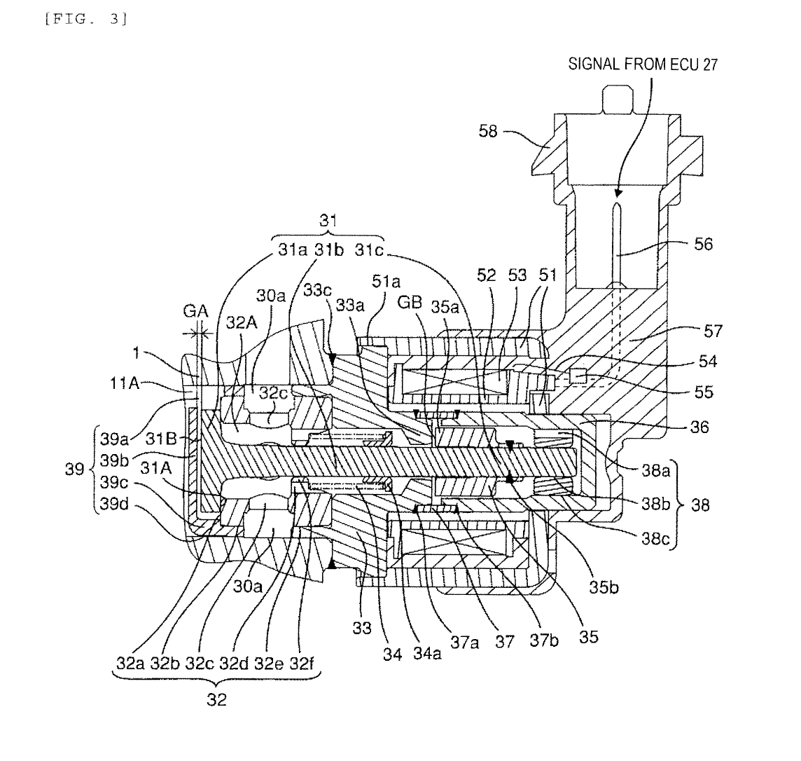

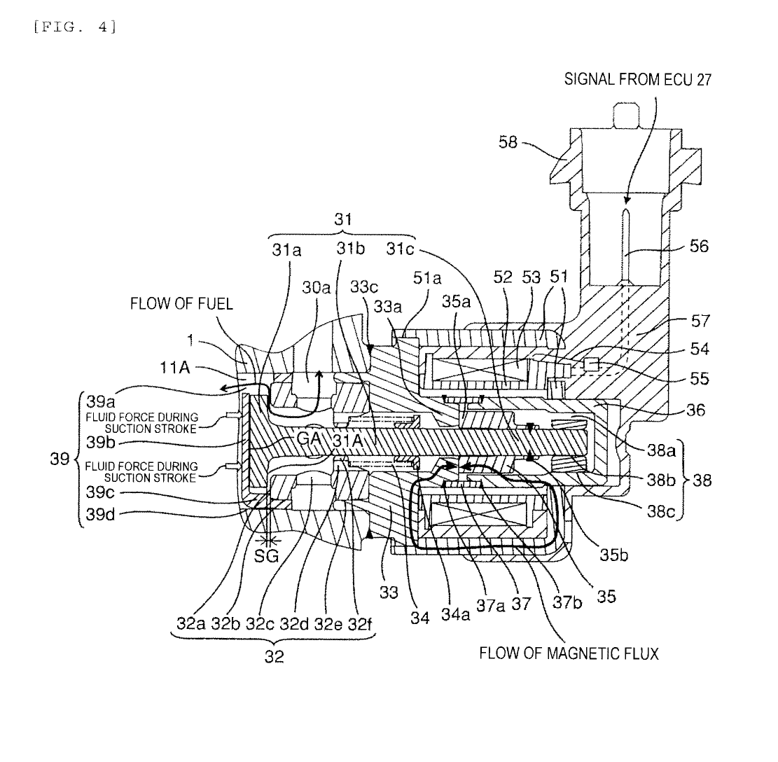

The plunger rod 31b of the valve-plunger unit 31 is inserted into a sliding portion 32f of the inlet valve seat housing 32 and an inner periphery of the sliding portion 38b of the guide 38, and a sliding gaps (clearance) exist respectively. Therefore, the valve-plunger unit 31, the anchor 35, and the spring stopper 34a are integrally movable leftward and rightward in FIG. 2, FIG. 3, and FIG. 4. Between the anchor 35 and the inner yoke 36, a gap (clearance) exists, so that the both members do not contact with each other.

The biasing force generated in the spring 34 is configured to be generated in a direction of separating the anchor 35 and the fixing core 33 via the spring stopper 34a.

An outer yoke 51 is fixed to the fixing core 33 by press-fitting a press-fit portion 51a. Between the outer yoke 51 and the inner yoke 36, a minute gap (clearance) exists. Accordingly, a structure in which the welding portions 37a and 37b are free from a load of a lateral load is achieved.

The electromagnetic coil 53 is provided in a space surrounded by the fixing core 33, the seal ring 37, the inner yoke 36, and the outer yoke 51. The coil is connected to a terminal 56 at a connecting portion 55 by a line 54, and the terminal 56 is connected to an engine control unit (hereinafter, referred to as ECU) 27. Therefore, a structure in which a signal (voltage) from the ECU 27 is loaded on the electromagnetic coil 53 is achieved.

When the voltage from the ECU 27 is loaded on the electromagnetic coil 53, a magnetic field is generated around the coil. Since the fixing core 33, the anchor 35, the inner yoke 36, and the outer yoke 51 are formed of a magnetic material, a flow of a magnetic flux is generated as illustrated in FIG. 4. Then, a magnetic attraction force is generated in a direction in which the magnetic sucking portion 33a of the fixing core 33 and a magnetic sucking portion 35a of the anchor 35 attract each other. Accordingly, the anchor 35 is attracted toward the fixing core 33, and a magnetic attraction force is generated in a direction of separating the valve member 31a as an inlet valve from the inlet valve seat portion 32a (valve-open direction).

Here, the larger the magnetic flux passing through the magnetic sucking portion 33a of the fixing core 33 and the magnetic sucking portion 35a of the anchor 35, the larger the generated magnetic attraction force. Since the seal ring 37 is formed of a non-magnetic material, the magnetic flux is not generated even when being exposed to a magnetic field (or if generated, only a relatively minute magnetic flux is generated). Therefore, an entire (or almost the entire) portion of the generated magnetic flux can pass through the magnetic sucking portion 33a of the fixing core 33 and the magnetic sucking portion 35a of the anchor 35, and hence the magnetic attraction force can be generated efficiently.

In a state of non-excitation in which the electromagnetic coil 53 is not excited, and when there is no fluid differential pressure between the inlet flow channel 10c (inlet port 30a) and the pressurizing chamber 11, the plunger rod 31b takes a state of being moved rightward in the drawing by the spring 34 as illustrated in FIG. 3. In this state, the valve-closed state in which the valve member 31a and the inlet valve seat portion 32a are in contact with each other is assumed, so that the pressurizing chamber 11 is isolated from the inlet port 30a.

When the piston plunger 2 is in a state of a suction stroke being displaced downward in FIG. 2 by the rotation of the cam, the capacity of the pressurizing chamber 11 is increased, and the fuel pressure in the pressurizing chamber 11 is reduced. When the fuel pressure in the pressurizing chamber 11 is reduced to a level lower than the pressure in the inlet flow channel 10c (inlet port 30a) in this stroke, a valve opening force due to the fluid differential pressure of the fuel (a force of causing the valve member 31a to be displaced leftward in FIG. 1) is generated in the valve member 31a.

The valve member 31a is set to overcome the biasing force of the spring 34, move in the direction of separating from the inlet valve seat portion 32a, and communicate the pressurizing chamber 11 and the inlet port 30a with the valve-opening force on the basis of the fluid differential pressure. When the fluid differential pressure is large, the magnetic sucking portion 35a of the anchor 35 is brought into a state of coming into contact with the magnetic sucking portion 33a of the fixing core 33, and the valve member 31a stops motion and takes a complete valve-open state. In other words, the magnetic sucking portion 33a of the fixing core 33 functions as a stopper of a valve-opening motion of the plunger rod 31b, the anchor 35, and the spring stopper 34a which moves integrally.

When the fluid differential pressure is small, the magnetic sucking portion 35a does not come into a state of coming into contact with the magnetic sucking portion 33a, and the valve member 31a does not take the complete valve-open state.

When a control signal from the ECU 27 is applied to the electromagnetic coil 53 in this state, a magnetic attraction force is applied to the valve-plunger unit 31 in the valve-open direction as described above.

When the valve member 31a is completely opened, the valve-open state is maintained. In contrast, when the valve member 31a is not opened completely, the valve-open motion of the valve member 31a is accelerated, so that the magnetic sucking portion 35a of the anchor 35 comes into contact with the magnetic sucking portion 33a of the fixing core 33, and the valve member 31a stops the motion and takes a complete valve-open state. In other words, in this case as well, the magnetic sucking portion 33a of the fixing core 33 functions as a stopper of a valve-opening motion of the plunger rod 31b, the anchor 35, and the spring stopper 34a which moves integrally.

Consequently, a state in which the valve member 31a is apart from the inlet valve seat portion 32a, that is, a state in which the valve member 31a opens the inlet mouth 32A is maintained, and the fuel flows from the inlet port 30a through the inlet channel portion 32c of the inlet valve seat housing 32 and the inlet mouth 32A, passes through a gap SG between the valve member 31a and the inlet valve seat portion 32a, and flows into the pressurizing chamber 11.

When the piston plunger 2 terminates the suction stroke while maintaining a state of applying an input voltage to the electromagnetic coil 53 and the piston plunger 2 is transferred to a compression stroke of being displaced upward in FIG. 2, since the magnetic attraction force is maintained, the valve member 31a is kept in an opened state.

The capacity of the pressurizing chamber 11 is reduced in association with the compressing motion of the piston plunger 2. However, in this state, since fuel taken into the pressurizing chamber 11 once is returned through the gap SG between the valve member 31a and the inlet valve seat portion 32a and the inlet mouth 32A to the inlet flow channel 10c (inlet port 30a), the pressure in the pressurizing chamber does not rise. This stroke is referred to as a return stroke.

When the signal (voltage) from the ECU 27 is released and energization to the electromagnetic coil 53 is stopped, the magnetic attraction force working on the valve-plunger unit 31 is erased after a certain period of time (after magnetic and mechanical delay time). Since the biasing force by the spring 34 acts on the valve member 31a, if the magnetic attraction force acting on the valve-plunger unit 31 is disappeared, the valve member 31a comes into contact with the inlet valve seat portion by the biasing force by the spring 34 and is brought into a valve-closed state. From this time point, the fuel pressure in the pressurizing chamber 11 rises together with the upward motion of the piston plunger 2. When the fuel pressure reaches or exceeds the pressure in the fuel discharge port 12, high-pressure discharge of the fuel remaining in the pressurizing chamber 11 is performed via the discharge valve mechanism 8, and is supplied to the common rail 23. This stroke is referred to as a discharge stroke. In other words, the compression stroke of the piston plunger 2 (rising stroke in a range from the bottom dead point to the upper dead point) includes the return stroke and the discharge stroke.

By controlling the timing that release the energization to the electromagnetic coil 53, the amount of high-pressure fuel to be discharged can be controlled.

When the timing of releasing the energization to the electromagnetic coil 53 is moved ahead, the rate of the return stroke is small and the rate of the discharge stroke is large during the compression stroke. In other words, the amount of fuel to be returned to the inlet flow channel 10c (inlet port 30a) is small, and the amount of fuel discharged at a high pressure is increased.

In contrast, when the timing of releasing the input voltage is put off, the rate of the return stroke is large and the rate of the discharge stroke is small during the compression stroke. In other words, the amount of fuel to be returned to the inlet flow channel 10c is large, and the amount of fuel discharged at a high pressure is decreased. The timing of releasing the energization to the electromagnetic coil 53 is controlled by a command from the ECU 27.

With the configuration described thus far, by controlling the timing that release the energization to the electromagnetic coil 53, the amount of fuel to be discharged at a high pressure can be controlled to an amount required by the internal combustion engine.

In this manner, the fuel introduced into the fuel inlet mouth 10a is pressurized to a high pressure by a required amount by a reciprocal motion of the piston plunger 2 in the pressurizing chamber 11 of the pump housing 1, and is pumped from the fuel discharge mouth 12 to the common rail 23.

The common rail 23 includes injectors 24 and a pressure sensor 26 mounted thereon. The injectors 24 are mounted by the number corresponding to the number of cylinders of the internal combustion engine, and open and close in accordance with the control signal from the ECU 27 to inject the fuel into the cylinders.

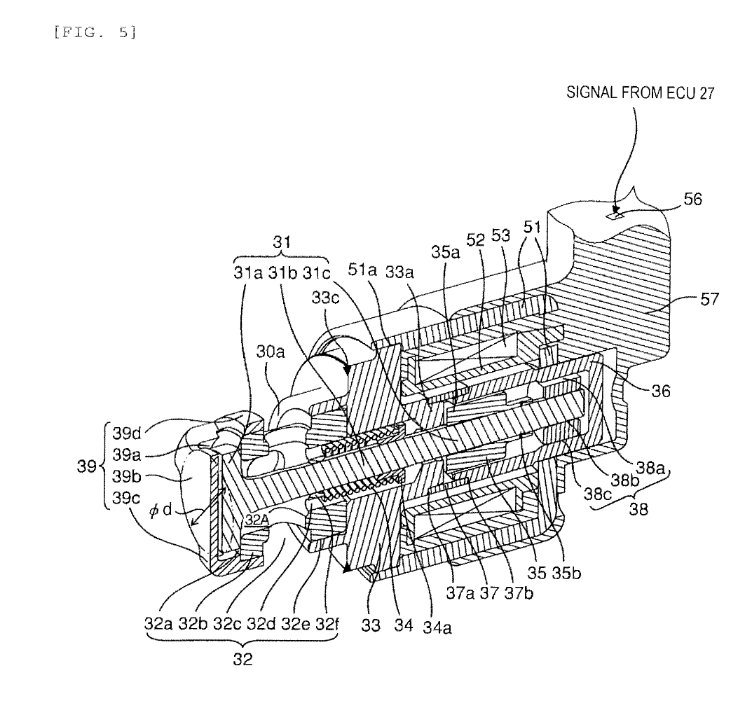

A diameter φd of the flat plate portion 39b of the protector 39 illustrated in FIG. 5 is set to be larger than the diameter of the valve member 31a. The valve member 31a can be displaced finely in the direction of the diameter thereof owing to the clearance of the sliding portion or the like. However, the valve member 31a is set not to be protruded from the diameter of the flat plate portion 39b of the protector 39 in any conditions. When the valve member 31a is opened, the pressurizing chamber 11 and the inlet port 30a communicate with each other via the opening portion 39a, and fuel flows through the opening portion 39a. The inlet valve seat housing 32 is press-fit to the inside of the protector 39 via the press-fit portion 32b and, in addition, the protector 39 is fixed to the pump housing 1 via the press-fit portion 39d. The disc-shaped flat plate portion 39b at the center of the protector 39 is integral with the ring-shaped press-fit portion 39d via the fixing arm portion 39c.

The clearance (gap) GA between the disc-shaped flat plate portion 39b at the center of the protector 39 and the valve member 31a is always larger than the clearance (magnetic gap) GA between the magnetic sucking portion 33a and the magnetic sucking portion 35a. In other words, even when the magnetic sucking portion 33a and the magnetic sucking portion 35a are in contact with each other and hence the valve member 31a is completely opened, the disc-shaped flat plate portion 39b at a center of the protector 39 and an end surface portion of the valve member 31a do not come into contact with each other, and a minute clearance (gap) GA exists.

At the time of return stroke, the fuel in the pressurizing chamber 11 passes through the opening portion 39a at the entrance of the pressurizing chamber and flows to the inlet port 30a. At this time, a fluid force is generated in the direction of opening the valve member 31a in the valve member 31a. However, part of the fluid force, or major part thereof is received by the flat plate portion 39b of the protector 39. As a result, the sum of the fluid force acting on the valve member 31a and the biasing force generated by the spring 34 becomes smaller than the magnetic attraction force. In particular, since the valve member 31a does not protrude from the diameter of the flat plate portion 39b of the protector 39, this effect is obvious.

The magnetic attraction force is strongest when the magnetic sucking portion 33a and the magnetic sucking portion 35a are in contact with each other. Since the magnetic sucking portion 33a and the magnetic sucking portion 35a are in contact with each other when the valve member 31a is completely opened, the magnetic attraction force not smaller than the fluid force is secured.

A time period after the disconnection of signal (voltage) from the ECU 27 to the valve member 31a, from the start of the valve-close motion of the valve member 31a until valve-close after contact with the inlet valve seat portion 32a is referred to as “valve-close time”. When the valve-close time is too long, there arises a problem that the upward motion of the plunger is finished before the valve member 31a is completely closed, and is transferred to a downward motion, so that a high-pressure discharge cannot be performed.

At the time when the valve member 31a is completely opened, in a case where a clearance between the flat plate portion 39b of the protector 39 and the valve member 31a is zero (contact state), fuel enters a space between the valve member 31a and the flat plate portion 39b of the protector 39, and a long time is required for the valve member 31a to start the valve-close motion, so that the valve-close time becomes long. Consequently, the above-described problem may occur.

In this example, since the magnetic sucking portion 33a and the magnetic sucking portion 35a come into contact with each other first even at the time of opening the valve member 31a, the clearance between the flat plate portion 39b of the protector 39 and the valve member 31a does not become zero (contact state). Accordingly, the problem that the valve-close time is elongated, and hence the high-pressure fuel supply pump cannot discharge at a high pressure does not occur.

From the description given above, in this example, the following two points can be established simultaneously when the valve member 31a is completely opened.

(1) Since the magnetic sucking portion 33a and the magnetic sucking portion 35a are in contact with each other, a sufficient magnetic attraction force is secured. (2) Since the clearance between the flat plate portion 39b of the protector 39 and the valve member 31a does not become zero, and the valve-close time of the valve member 31a may be reduced.

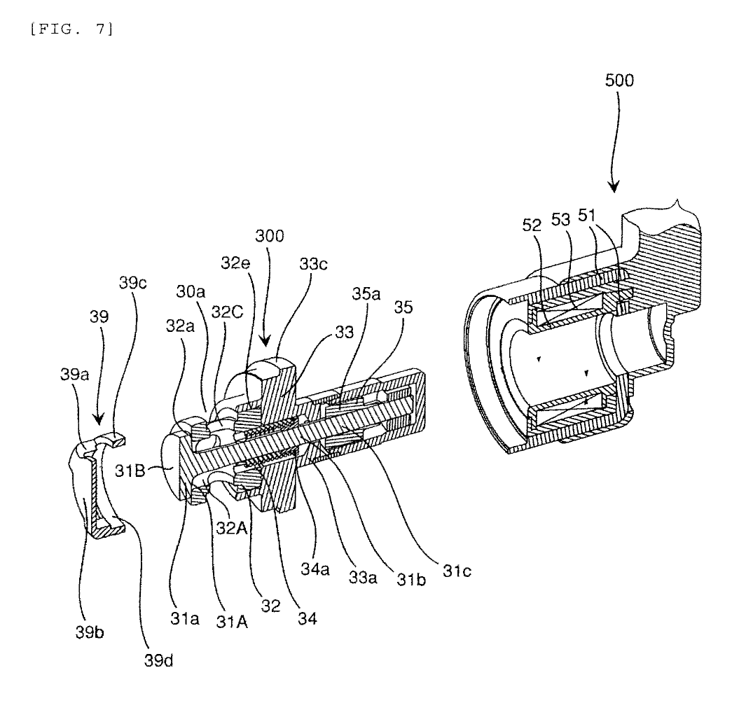

FIG. 7 illustrates a state before assembling the electromagnetically-driven inlet valve mechanism 30 into the pump housing 1.

In this example, first of all, units are prepared as an inlet valve unit 300 and a connector unit 500, respectively. Subsequently, the press-fit portion 32b on the outer periphery of the inlet valve seat portion 32a of the inlet valve unit 300 is fixed to an inner periphery of the ring-shaped press-fit portion 39d of the protector 39 by press-fitting. Subsequently, the protector 9 is fixed to the pump housing 1 by press-fitting. Subsequently, the welding portion 37c is joined by welding over the entire circumference. In this example, the laser welding is used as welding. In this state, the connector unit 500 is fixed to the fixing core 33 by being press-fit. Accordingly, the orientation of the connector 58 can be selected freely.

### REFERENCE SIGNS LIST

1 pump housing
1a pressure-bonded surface
1A depressed portion
1B clearance
2 piston plunger
2a large diameter portion
2b small diameter portion
3 tappet
4 spring
5 cam
6 cylinder
6a pressure-bonded portion
7 cylinder holder
7a cylindrical fitting portion
7c inner peripheral cylindrical surface
7g screw
8 discharge valve mechanism
8a seat member
8b discharge valve
8c discharge valve spring
8d holding member
8e, 33c, 35b, 37a, and 37b welding portion
9 metallic diaphragm damper
10a intake mouth
10b, 10c inlet flow channel
10f seal chamber
11 pressurizing chamber
11A inlet opening
11B bore
12 discharge mouth
13 plunger seal
15 retainer
21 feed pump
30 electromagnetically-driven inlet valve mechanism
30a inlet port
30A bore
31 valve-plunger unit
31a (as a inlet valve) valve member
31b plunger rod
31c anchor fixing portion
32 inlet valve seat housing
32a inlet valve seat portion
32b, 32e, 38c, 39d, 51a press-fit portion
32c inlet channel portion
32d fuel communication channel
32f, 38b sliding portion
32A inlet mouth
33 fixing core
33a, 35a magnetic sucking portion
34 spring
34a spring stopper
35 anchor
36 inner yoke
37 seal ring
38 guide
38a, 39a opening portion
39 protector
39b flat plate portion
39c fixing arm portion
51 outer yoke
53 electromagnetic coil
101 inlet joint
300 inlet valve unit
500 connector unit

1. A high-pressure fuel supply pump provided with an electromagnetically-driven inlet valve mounted at an inlet opening of a pressurizing chamber formed in a pump housing and configured to adjust fuel spilled from the pressurizing chamber comprising:
a valve member having a seat surface that comes into abutment with a valve seat;
a plunger rod positioned on the seat surface side of the valve member and configured to operate the valve member by an electromagnetic force; and
a protector configured to face a surface of the valve member on the side opposite to the seat surface with a gap therebetween when an anchor for driving the plunger rod comes into contact with a stopper and the plunger rod makes a full stroke in an opening direction, wherein
the protector is provided between the surface of the valve member on the side opposite to the seat surface and an inlet opening of the pressurizing chamber.

2. The high-pressure fuel supply pump according to claim 1, wherein
the gap between the valve member and the protector is always larger than the gap between the anchor and the stopper.

3. The high-pressure fuel supply pump according to claim 1, comprising:
a valve-closing spring configured to bias the plunger rod in the valve-close direction of the valve member, wherein
the inlet valve reaches a fully-opened position at a maximum compressed position of the valve-closing spring and at that time, the distance between the valve member and the protector becomes a minimum distance larger than zero.

4. The high-pressure fuel supply pump according to claim 1, wherein
the valve member and the plunger rod are integrated with each other.

5. The high-pressure fuel supply pump according to claim 1, wherein
the plunger rod and the anchor are integrated.

6. The high-pressure fuel supply pump according to claim 1, wherein
the electromagnetic force is generated in a direction of separating the valve member from the valve seat (the valve-open direction of the valve member).

7. The high-pressure fuel supply pump according to claim 1, wherein
the electromagnetic force generates between the anchor and the stopper.

8. The high-pressure fuel supply pump according to claim 1, wherein
the protector is fixed to a member on which the valve seat is formed.

9. The high-pressure fuel supply pump according to claim 1, wherein
the protector and the member on which the valve seat is formed are press-fit separately into the pump housing portion of the high-pressure fuel supply pump.

10. A high-pressure fuel supply pump provided with an electromagnetically-driven inlet valve mounted at an inlet opening of a pressurizing chamber formed in a pump housing and configured to adjust fuel flowing into the pressurizing chamber and spilled from the pressurizing chamber comprising:
a valve member having a seat surface that comes into abutment with a valve seat; and
a plunger rod positioned on the seat surface side of the valve member and configured to operate the valve member by an electromagnetic force, wherein
the anchor for driving the plunger rod comes into contact with the stopper, a wall surface member having a flat disc-shaped portion facing an end surface portion of the valve member mounted on the plunger rod on the side opposite to the valve seat side is provided,
the wall surface member is provided between the surface of the valve member on the side opposite to the seat surface and an inlet opening of the pressurizing chamber, and
a thin fuel film is interposed between an end surface portion of the valve member and the flat disc-shaped portion of the wall surface member so as to keep the both out of contact in a state in which the valve member makes a full stroke in the valve-open direction.

11. The high-pressure fuel supply pump according to claim 10, comprising:
a valve-closing spring configured to bias the plunger rod in the valve-close direction of the valve member, wherein
the valve reaches a fully-opened position at a maximum compressed position of the valve-closing spring and at that time, the distance between the valve member and the protector becomes a minimum distance larger than zero.

12. The high-pressure fuel supply pump according to claim 10, comprising:
an electromagnetically-driven mechanism configured to operate the plunger rod by the electromagnetic force, and
an anchor for the electromagnetically-driven mechanism fixed to the plunger rod, wherein
the anchor comes into contact with the stopper when the plunger rod makes a full stroke, and
a gap between the valve member and the protector is always larger than the gap between the anchor and the stopper.
